(19) United States
(12) Patent Application Publication
(10) Pub. No.: US 2012/0048729 A1
(43) Pub. Date: Mar. 1, 2012

(54) ELECTRICALLY NON-CONDUCTIVE MATERIALS FOR ELECTROCHEMICAL CELLS

(75) Inventors: Yuriy V. Mikhaylik, Tucson, AZ (US); John D. Affinito, Tucson, AZ (US); Igor Kovalev, Vail, AZ (US); Riley Oaks Schock, Tucson, AZ (US)

(73) Assignee: Sion Power Corporation, Tucson, AZ (US)

(21) Appl. No.: 13/216,559

(22) Filed: Aug. 24, 2011

Related U.S. Application Data
(60) Provisional application No. 61/376,554, filed on Aug. 24, 2010.

(51) Int. Cl. C25B 9/00; H01M 2/14; H01M 10/02; H01R 43/00

(52) U.S. Cl. 204/252; 29/825; 429/246

(57) ABSTRACT

Articles, systems, and methods related to the configuration of electrically non-conductive materials and related components in electrochemical cells are generally described. Some inventive electrochemical cell configurations include an electrically non-conductive material (e.g., as part of the electrolyte) that is configured to wrap around the edge of an electrode to prevent short circuiting of the electrochemical cell. In some embodiments, the electrically non-conductive material layer can be arranged such that it includes first and second portions (one on either side of an electrode) as well as a third portion adjacent the edge of the electrode that directly connects (and, in some cases, is substantially continuous with) the first and second portions. The electrically non-conductive material layer can be relatively thin while maintaining relatively high electrical insulation between the anode and the cathode, allowing one to produce an electrochemical cell with a relatively low mass and/or volume. The arrangements described above can be formed, for example, by forming a multi-layer structure comprising an electrode and an electrically non-conductive material layer (e.g., as a coating), and folding the multi-layer structure such that the electrically non-conductive material covers the convex surface portion of the resulting crease.

### RELATED APPLICATIONS

This application claims priority under 35 U.S.C. §119(e) to U.S. Provisional Patent Application Ser. No. 61/376,554, filed Aug. 24, 2010, and entitled “Electrically Non-Conductive Materials for Electrochemical Cells,” which is incorporated herein by reference in its entirety for all purposes.

### FIELD OF INVENTION

Articles, systems, and methods related to the configuration of electrically non-conductive materials in electrochemical cells are generally described.

### BACKGROUND

A typical electrochemical cell includes a cathode and an anode which participate in an electrochemical reaction. Typical electrochemical cells also include an electrolyte and porous separator, which allows ions to be transported between the electrodes, but does not allow electrons to be conducted between them. By maintaining electrical insulation between the anode and the cathode, an external device can be powered by transporting electrons from one electrode of the electrochemical cell, through the device, and to the other electrode of the cell. If the electrically insulating electrolyte fails, electrons will be transported directly between the cathode and the anode of the cell, rather than through the external device, limiting the battery's effectiveness. Many electrochemical cells currently in use are prone to failure of the electrically insulating electrolyte (e.g., via failure of a solid separator). Failure can be especially common at the perimeter of the electrolyte. For example, if the edges of a separator material within the electrolyte are rough or jagged, the anode and the cathode might be allowed to exchange electrons through the roughened edge. This problem can be magnified when an anisotropic force defining a pressure is applied to the cell, as a reduction in the distance between the anode and the cathode can increase the possibility of a short circuit within the cell.

Accordingly, improved articles, systems, and methods are desirable.

### SUMMARY OF THE INVENTION

Electrically non-conductive materials for use in electrochemical cells (e.g., in an electrolyte region), and associated systems and methods, are provided. The subject matter of the present invention involves, in some cases, interrelated products, alternative solutions to a particular problem, and/or a plurality of different uses of one or more systems and/or articles.

In one aspect, a method is described. The method can comprise, in some embodiments, providing a multi-layer structure comprising an electrically non-conductive material layer, and a substantially continuous electrode including an electrode surface oriented away from the electrically non-conductive material layer, and defining a first electrode surface portion and a second electrode surface portion. The method can further comprise folding the multi-layer structure along an axis such that the first electrode surface portion faces the second electrode surface portion.

In another aspect, a multi-layer structure is provided. In some embodiments, a cross-section taken through the bulk of the multi-layer structure comprises a first electrode layer portion having a first polarity; a second electrode layer portion having a second polarity that is opposite the first polarity; a third electrode layer portion having the first polarity; a first electrically non-conductive material layer portion between the first and second electrode layer portions; and a second electrically non-conductive material layer portion between the second and third electrode portions. In some cases, the first and second electrically non-conductive material layer portions are directly connected by a third portion of an electrically non-conductive material. In some instances, the average distance between the first and second electrode layer portion and/or the average distance between the second and third electrode layer portion is less than about 100 microns.

In another aspect, an electrochemical cell is described. The electrochemical cell can comprise, in some embodiments, a first electrode portion with a first polarity; a second electrode portion with a second polarity that is opposite the first polarity; a third electrode portion with the first polarity; and a substantially continuous, electrically non-conductive material layer having a first portion between the first electrode portion and the second electrode portion, a second portion between the second electrode portion and the third electrode portion, and a third portion in direct contact with the first and second portions. In some cases, the average distance between the first and second electrode layer portions and/or the average distance between the second and third electrode layer portion is less than about 100 microns.

In some cases, the electrochemical cell can comprise a substrate with a first substrate surface portion and a second substrate surface portion facing away from the first substrate surface portion; a first electrode with a first portion adjacent the first substrate surface portion and a second portion adjacent the second substrate surface portion; a second electrode with a first surface portion facing the first portion of the first electrode and a second surface portion facing away from the first surface portion of the second electrode; and a substantially continuous, electrically non-conductive material layer having a first portion between the first portion of the first electrode and the first surface portion of the second electrode, a second portion adjacent the second surface portion of the first electrode, and a third portion in direct contact with the first and second portions.

In some embodiments, the electrochemical cell can comprise a multi-layer structure including the following layer portions positioned in the order described, optionally with any number of other layers of the same or different material intervening the described layers: a first electrode layer portion having a first polarity; a second electrode layer portion having a second polarity; a third electrode layer portion having the second polarity; and a fourth electrode layer portion having the first polarity. In some cases, the second electrode layer portion and the third electrode layer portion are portions of a single, substantially continuous electrode, and no electrode portion having the first polarity is positioned intervening the second and third electrode layer portions.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control. All patents and patent applications disclosed herein are incorporated by reference in their entirety for all purposes.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1D are exemplary cross-sectional schematic illustrations outlining the fabrication of a multi-layer structure, according to one set of embodiments;

FIG. 2 is, according to some embodiments, an exemplary cross-sectional schematic illustration of a multi-layer structure;

FIG. 3 is an exemplary cross-sectional schematic illustration of a plurality of multi-layer structures, according to some embodiments;

FIGS. 4A-4B are (A) an exemplary cross-sectional schematic diagram and (B) an exemplary top-view schematic diagram of an electrochemical cell, according to one set of embodiments; and

FIG. 5 is an exemplary cross-sectional schematic diagram of an electrochemical cell.

### DETAILED DESCRIPTION

Articles, systems, and methods related to the configuration of electrically non-conductive materials and related components in electrochemical cells are generally described. Some inventive electrochemical cell configurations include an electrically non-conductive material (e.g., as part of the electrolyte) that is configured to wrap around the edge of an electrode to prevent short circuiting of the electrochemical cell. In some embodiments, the electrically non-conductive material layer can be arranged such that it includes first and second portions (one on either side of an electrode) as well as a third portion adjacent the edge of the electrode that directly connects (and, in some cases, is substantially continuous with) the first and second portions. The electrically non-conductive material layer can be relatively thin while maintaining relatively high electrical insulation between the anode and the cathode, allowing one to produce an electrochemical cell with a relatively low mass and/or volume. The arrangements described above can be formed, for example, by forming a multi-layer structure comprising an electrode and an electrically non-conductive material layer (e.g., as a coating), and folding the multi-layer structure such that the electrically non-conductive material covers the convex surface portion of the resulting crease.

The inventors have discovered that, in some embodiments, it can be particularly advantageous to form the electrically non-conductive material layer over an electrode (e.g., via casting, evaporative deposition, spin-coating, or another process) to form the multi-layer structure. Producing a multi-layer structure via this method can be relatively easy, fast, and inexpensive relative to methods in which, for example, the electrically non-conductive material layer and electrode are formed as separate materials and joined together to form the multi-layer structure, which might require complicated alignment of the electrode and the electrically non-conductive material. In addition, forming the electrically non-conductive material layer over the electrode can be relatively easy, fast, and inexpensive relative to systems in which multiple, individual electrodes are placed or formed on an electrically non-conductive material, which can also require careful alignment during both electrode attachment and during folding. Moreover, forming the electrically non-conductive material layer over an electrode can also allow for control of the thickness of the electrically non-conductive material. The formation of relatively thin layers of electrically non-conductive material can reduce the volume and/or mass of the multi-layer structure, thereby increasing the specific energy and energy density of the resulting electrochemical cell.

The inventors have also discovered that short circuiting between the anode and the cathode can be more prevalent when an anisotropic force (defining a pressure) is applied to the electrochemical cell, as a reduction in the distance between the anode and the cathode can increase the possibility of a short circuit within the cell. U.S. Patent Publication No. 2010/0035128 to Scordilis-Kelley et al. filed on Aug. 4, 2009, and entitled “Application of Force in Electrochemical Cells,” (which is incorporated herein by reference in its entirety for all purposes) describes the application of forces in electrochemical cells for improved electrode chemistry, morphology, and/or other characteristics, which can improve performance. The present invention involves, in one aspect, the recognition that the use of particular arrangements of electrically non-conductive materials can allow for the application of a force to an electrochemical cell without producing short circuits between the anode and the cathode. In addition, the configurations of electrically non-conductive materials described herein can reduce the probability of a short circuit within the cell after repeated charging and discharging cycles (e.g., due to dissolution and re-plating of electrode materials).

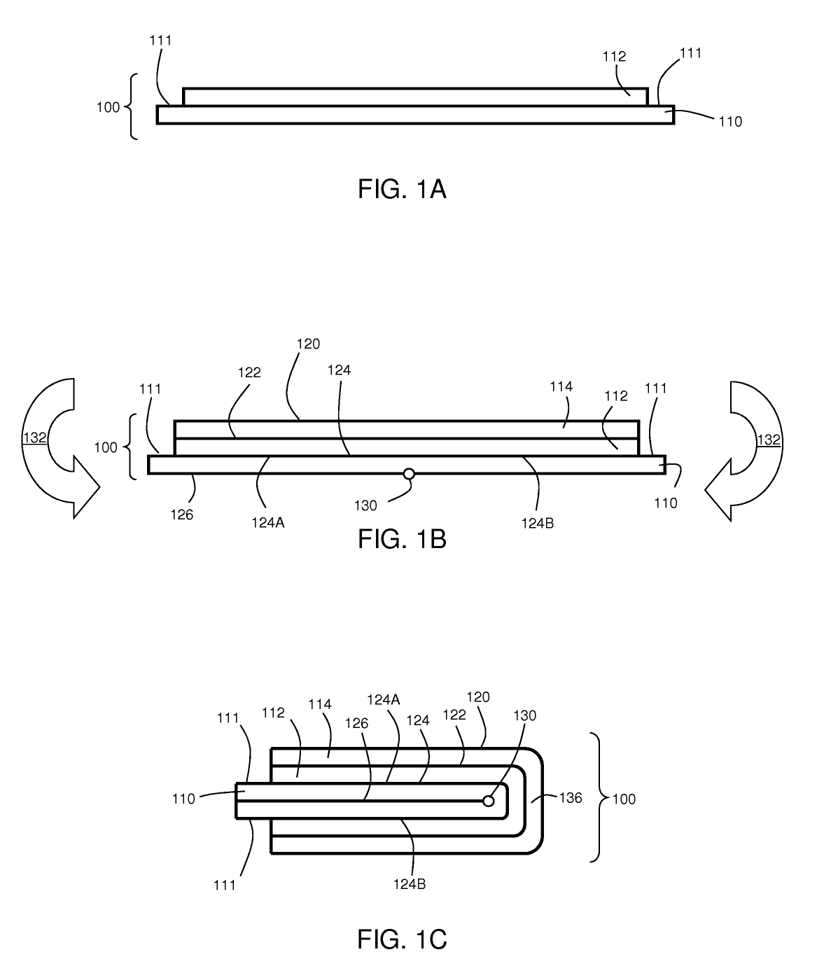

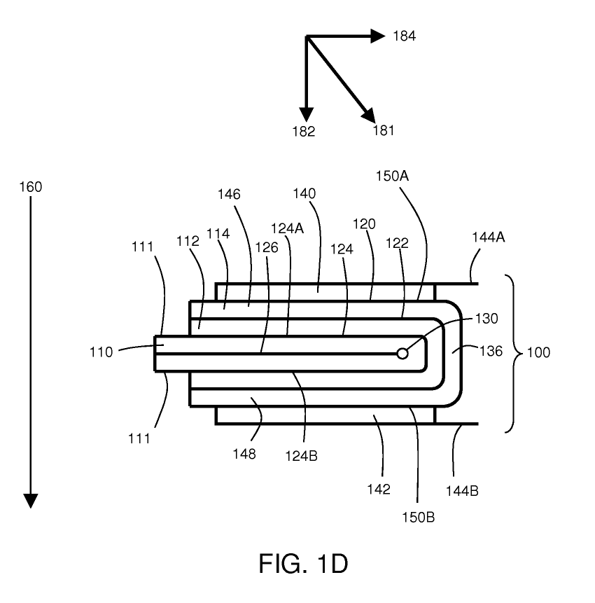

FIGS. 1A-1D include exemplary cross-sectional schematic diagrams illustrating a method of arranging an electrically non-conductive material layer, according to one set of embodiments. In FIG. 1A, multi-layer structure 100 comprises substrate 110 and electrode 112 positioned adjacent each other. In some embodiments, electrode 112 can be formed over substrate 110. For example, electrode 112 might be deposited (e.g., via vacuum deposition of a metal, mixture of metals, or other suitable material), onto substrate 110. As another example, electrode 112 might be formed on substrate 110 by a casting process (e.g., by depositing and drying a slurry comprising electrode active material on a substrate). In other embodiments, electrode 112 and substrate 110 might be formed as separate entities and adhered or otherwise joined together to form the structure illustrated in FIG. 1A. In still other embodiments, substrate 110 and electrode 112 might be provided as a pre-assembled multi-layered structure.

In some embodiments, such as the set of embodiments illustrated in FIG. 1A, electrode 112 does not completely cover substrate 110, but rather, edge portions 111 of substrate 110 are left exposed. Such arrangements can be useful in forming electrical contacts, for example, when the substrate supports or is used as a current collector in the assembled electrochemical cell. It should be understood, however, that in other embodiments, electrode 112 can be arranged to substantially completely cover substrate 110.

In FIG. 1B, multi-layer structure 100 further comprises electrically non-conductive material layer 114 positioned adjacent electrode 112, such that electrode 112 is between electrically non-conductive material layer 114 and substrate 110. As described in more detail below, the electrically non-conductive material layer 114 can form all or part of the electrolyte of the electrochemical cell formed from multi-layer structure 100, in some cases. In some embodiments, electrically non-conductive material layer 114 is adhered to electrode 112. In some instances, at least a portion of electrically non-conductive material layer 114 is covalently bonded to electrode 112.

In some embodiments, electrically non-conductive material layer 114 can be formed over electrode 112. For example, electrically non-conductive material layer 114 might be applied over electrode 112 and formed in place, for example using a casting process (e.g., by depositing and drying a slurry comprising electrically non-conductive material on an electrode). Exemplary methods for performing such a deposition are described, for example, in PCT Publication No. WO 99/33125 to Carlson et al. and in U.S. Pat. No. 5,194,341 to Bagley et al., each of which is incorporated by reference in its entirety for all purposes. In some embodiments, the electrically non-conductive material layer can be deposited by methods such as electron beam evaporation, vacuum thermal evaporation, laser ablation, chemical vapor deposition, thermal evaporation, plasma assisted chemical vacuum deposition, laser enhanced chemical vapor deposition, jet vapor deposition, and extrusion. The electrically non-conductive material layer may also be deposited by spin-coating techniques. A method for depositing, for example, crosslinked polymer layers includes flash evaporation methods, for example, as described in U.S. Pat. No. 4,954,371 to Yializis. A method for depositing, for example, crosslinked polymer layers comprising lithium salts may include flash evaporation methods, for example, as described in U.S. Pat. No. 5,681,615 to Affinito et al. The technique used for depositing the electrically non-conductive material layer may depend on the type of material being deposited, the thickness of the layer, etc. Depositing the electrically non-conductive material layer on an electrode can be advantageous, in some embodiments, because it can allow for the deposition of relatively thin layers of electrically non-conductive material, which can reduce the size and weight of the final electrochemical cell.

In other embodiments, electrically non-conductive material layer 114, substrate 110, and electrode 112 can be formed as separate entities and adhered or otherwise joined to the rest of the multi-layer structure. In still other embodiments, substrate 110, electrode 112, and electrically non-conductive material layer 114 might be provided as a pre-assembled multi-layered structure.

The substrate 110, electrode 112 and/or the electrically non-conductive material layer 114 (or other layers of the multi-layer structure) can be a substantially continuous layer, in some embodiments. “Substantially continuous,” as used to describe a relationship between two sections or layers of a structure, means that any region of the structure between the sections or layers is essentially identical to the sections or layers. E.g., a substantially continuous sheet of material, folded upon itself or folded around a different material, can define two or more sections that remain part of the substantially continuous sheet.

In some embodiments, the substrate 110, electrode 112, electrically non-conductive material layer 114, and/or other material layers described herein can be substantially free of macroscopic discontinuities. A layer that is “substantially free of macroscopic discontinuities” is one that includes no region with a maximum cross-sectional dimension measured substantially parallel to the layer that is greater than the thickness of the layer, made up of a material (or mixture of materials) that is different than the composition of the rest of the layer. As specific examples, a layer with substantially no voids can be substantially free of macroscopic discontinuities. In addition, a porous material layer can be substantially free of macroscopic discontinuities if the maximum cross-sectional dimension of the pores within the layer is less than the thickness of the layer. A porous material with pore sizes greater than the thickness of the layer of porous material, however, would not be substantially free of macroscopic discontinuities. In addition, a material that includes a bulk material and an island of a second material with a maximum cross-sectional dimension greater than the thickness of the material within the bulk material would not be substantially free of macroscopic discontinuities.

As shown in FIG. 1B, electrically non-conductive material layer 114 includes a first substantially planar surface 120 facing away from electrode 112 and substrate 110 and a second substantially planar surface (at interface 122) facing electrode 112 and substrate 110. In addition, electrode 112 includes a first substantially planar surface (at interface 122) facing electrically non-conductive material layer 114 and facing away from substrate 110 as well as a second substantially planar surface (at interface 124) facing substrate 110 and facing away from electrically non-conductive material layer 114. Substrate 110 includes a first substantially planar surface (at interface 124) facing electrode 112 and electrically non-conductive material layer 114 and a second substantially planar surface 126 facing away from electrode 112 and electrically non-conductive material layer 114.

As used herein, a surface (or surface portion) is said to be “facing” an object when the surface and the object are substantially parallel, and a line extending normal to and away from the bulk of the material comprising the surface intersects the object. For example, a first surface (or first surface portion) and a second surface (or second surface portion) can be facing each other if a line normal to the first surface and extending away from the bulk of the material comprising the first surface intersects the second surface. A surface and a layer can be facing each other if a line normal to the surface and extending away from the bulk of the material comprising the surface intersects the layer. A surface can be facing another object when it is in contact with the other object, or when one or more intermediate materials are positioned between the surface and the other object. For example, two surfaces that are facing each other can be in contact or can include one or more intermediate materials between them.

As used herein, a surface (or surface portion) is said to be “facing away from” an object when the surface and the object are substantially parallel, and no line extending normal to and away from the bulk of the material comprising the surface intersects the object. For example, a first surface (or first surface portion) and a second surface (or second surface portion) can be facing away from each other if no line normal to the first surface and extending away from the bulk of the material comprising the first surface intersects the second surface. A surface and a layer can be facing away from each other if a line normal to the surface and extending away from the bulk of the material comprising the surface intersects the layer. In some embodiments, a surface and another object (e.g., another surface, a layer, etc.) can be substantially parallel if the maximum angle defined by the surface and the object is less than about 10°, less than about 5°, less than about 2°, or less than about 1°.

The multi-layered structure can be folded along an axis to form a folded structure. In some embodiments, the multi-layered structure can be folded such that first and second portions of a surface of the electrode (e.g., first and second portions of a surface that faces away from the electrically non-conductive material layer) face each other. For example, in the set of embodiments illustrated in FIGS. 1B-1C, multi-layer structure 100 in FIG. 1B is folded along axis 130 (which extends into and out of the page) in the direction of arrows 132 to form the multi-layer structure illustrated in FIG. 1C. Surface portions 124A and 124B of electrode 112, originally both facing away from electrically non-conductive material layer 114 in FIG. 1B, have been reoriented in the structure of FIG. 1C such that they are facing each other. As shown in FIG. 1C, surface portions 124A and 124B include an intermediate material (substrate 110) between them. However, in other embodiments, surface portions 124A and 124B can be in contact.

By folding the multi-layer structure in this way, a portion 136 of the electrically non-conductive material layer is arranged such that it is oriented over the convex surface portion of the folded edge of electrode 112. In some cases, the electrically non-conductive material layer can substantially cover the edge of electrode 112. Having a portion (such as portion 136) of the electrically non-conductive material over the folded edge of electrode 112 can be useful in preventing short circuiting between electrode 112 and subsequent electrodes positioned over electrically non-conductive material layer 114.

Additional electrodes can also be included in the multi-layer structure. In the set of embodiments illustrated in FIG. 1D, electrodes 140 and 142 are positioned adjacent electrically non-conductive material layer 114. When arranged in this fashion, the electrically non-conductive material layer includes a first portion 146 between electrodes 112 and 140 and a second portion 148 between electrodes 112 and 142. In addition, first and second portions 146 and 148, respectively, are directly connected by portion 136. Two components or portions of a component are said to be “directly connected” or in “direct contact” when a line can be drawn connecting the two portions or components without passing through a region with a substantially different composition. In the set of embodiments illustrated in FIG. 1D, first and second portions 146 and 148 are also substantially continuous, although they need not be in all embodiments.

One or both of electrodes 140 and 142 can be formed over electrically non-conductive material layer 114. For example, electrode 140 and/or 142 might be deposited (e.g., via vacuum deposition) or cast (e.g., as a dried slurry), onto material layer 114. In other embodiments, electrode 140 and/or 142 can be formed as separate entities and adhered or otherwise joined to the multi-layer structure. While two additional electrodes 140 and 142 are illustrated in FIG. 1D, it should be understood that, in other embodiments, only one additional electrode (e.g., only electrode 140) can be included in the multi-layer structure.

In some embodiments, electrode 140 and/or electrode 142 are adhered to electrically non-conductive material layer 114. In some instances, at least a portion of electrode 140 and/or electrode 142 is covalently bonded to electrically non-conductive material layer 114.

The polarities of the electrodes can be selected to produce an electrochemical cell. In some embodiments, electrode 112 can be of a first polarity while electrode 140 (and 142, if present) can be of a second, opposite polarity. Generally, two electrodes are of opposite polarities if one is an anode and the other is a cathode. For example, electrode 112 can be an anode while electrode 140 (and 142, if present) can be a cathode. In other cases, electrode 112 can be a cathode while electrode 140 (and 142, if present) can be an anode.

Electrical contact can be made with the electrodes using any suitable technique. In the set of embodiments illustrated in FIG. 1D, electrical contact can be made with electrode 112 by using an electrically conductive substrate 110. Substrate 110 can include an electrically conductive bulk material or an electrically non-conductive bulk material coated with an electrically conductive material. Electrical contact can be made with electrodes 140 and/or 142 by incorporating current collectors 144A and 144B, respectively, into the multi-layer structure.

It should be understood that when a portion (e.g., layer, structure, region) is “on”, “adjacent”, “above”, “over”, “overlying”, or “supported by” another portion, it can be directly on the portion, or an intervening portion (e.g., layer, structure, region) also may be present. Similarly, when a portion is “below” or “underneath” another portion, it can be directly below the portion, or an intervening portion (e.g., layer, structure, region) also may be present. A portion that is “directly on”, “immediately adjacent”, “in contact with”, or “directly supported by” another portion means that no intervening portion is present. It should also be understood that when a portion is referred to as being “on”, “above”, “adjacent”, “over”, “overlying”, “in contact with”, “below”, or “supported by” another portion, it may cover the entire portion or a part of the portion.

It should be understood, therefore, that in the embodiments illustrated in FIGS. 1A-1D, and in other embodiments described herein, one or more additional layers may be positioned between the layers shown in the figures. For example, one or more additional layers may be positioned between substrate 110 and electrode 112 such as, for example, a release layer, which can be used to remove the substrate prior to folding multi-layer structure 100, as described below. In addition, one or more additional layers may be positioned between the release layer and the substrate. Furthermore, one or more layers may be positioned between other components of the multi-layer structure. For example, one or more primer layers can be positioned between a current collector and an electrode layer to facilitate adhesion between the layers. Examples of suitable primer layers are described in International Patent Application Serial No. PCT/US2008/012042, published as International Publication No. WO 2009/054987, filed Oct. 23, 2008, and entitled “Primer For Battery Electrode”, which is incorporated herein by reference in its entirety. In addition, one or more layers can be placed between an electrode and the electrically non-conductive material layer. For example, one or more layers can be positioned between electrode 112 and electrically non-conductive material layer 114, between electrode 140 and electrically non-conductive material layer 114, and/or between electrode 142 and electrically non-conductive material layer 114. Of course, in other embodiments, substrate 110 and electrode 112 can be in contact, electrode 112 and electrically non-conductive material layer 114 can be in contact, electrically non-conductive material layer 114 and electrode 140 can in contact, and/or electrically non-conductive material layer 114 and electrode 142 can be in contact. In addition, in some cases electrode 140 and/or 142 can be in contact with a current collector 144A and 144B, respectively, while in other cases, one or more materials can be positioned between electrode 140 and its current collector and/or electrode 142 and its current collector.

Some embodiments of the invention relate to the relative positions of the components (or portions thereof) described herein. In some embodiments, the multi-layer structure (or an electrochemical cell containing the multi-layer structure) can include the following layers positioned in the order described (e.g., traced along arrow 160 in FIG. 1D), optionally with any number of other layers of the same or different material intervening the described layers: a first electrode layer portion having a first polarity (e.g., a portion of electrode 140 in FIG. 1D), a second electrode layer portion having a second polarity (e.g., a portion of electrode 112 above substrate 110 in FIG. 1D), a third electrode layer portion having the second polarity (e.g., a portion of electrode 112 below substrate 110 in FIG. 1D), and a fourth electrode layer portion having the first polarity (e.g., a portion of electrode 142 in FIG. 1D). In some cases, as in the embodiments illustrated in FIG. 1D, the second and third electrode layer portions are portions of a single, substantially continuous electrode. In addition, in some cases, no electrode portion having the first polarity is positioned intervening the second and third electrode layer portions. In FIG. 1D, for example, only substrate 110 (which is not an electrode) is positioned between the second electrode layer portion (e.g., a portion of electrode 112 above substrate 110 in FIG. 1D) and the third electrode layer portion (e.g., a portion of electrode 112 below substrate 110 in FIG. 1D).

In some embodiments, a multi-layer structure (or an electrochemical cell containing the multi-layer structure) can include a substrate with a first substrate surface portion (e.g., a substrate surface portion adjacent surface portion 124A of electrode 112) and a second substrate surface portion facing away from the first substrate surface portion (e.g., a substrate surface portion adjacent surface portion 124B of electrode 112). The multi-layer structure can also comprise a first electrode with a first portion adjacent the first substrate surface portion (e.g., the portion of electrode 112 above the substrate in FIG. 1D) and a second portion adjacent the second substrate surface portion (e.g., the portion of electrode 112 below the substrate in FIG. 1D). In addition, the multi-layer structure can include a second electrode (e.g., electrode 140 in FIG. 1D, although electrode 142 could also be included, in addition to of in place of electrode 140) with a first surface portion facing the first portion of the first electrode (e.g., the surface of electrode 140 at interface 150A) and a second surface portion facing away from the first surface portion of the second electrode (e.g., the surfaces of electrode 140 facing top current collector 144A). In addition, the multi-layer structure can include a substantially continuous, electrically non-conductive material layer (e.g., layer 114 in FIG. 1D) having a first portion between the first portion of the first electrode and the first surface portion of the second electrode (e.g., portion 146 of electrically non-conductive material layer 114), a second portion adjacent the second surface portion of the first electrode (e.g., portion 148 of electrically non-conductive material layer 114), and a third portion in direct contact with the first and second portions (e.g., portion 136 of electrically non-conductive material layer 114).

The electrically non-conductive material layer can have any suitable thickness. In some embodiments, a relatively thin electrically non-conductive material layer can be employed, which can reduce the volume and/or weight of the multi-layer structure, thereby increasing the specific energy and energy density of an electrochemical cell fabricated using the multi-layer structure. In some embodiments, the electrically non-conductive material layer can have an average thickness of less than about 100 microns; less than about 50 microns; less than about 20 microns; less than about 10 microns; less than about 5 microns; less than about 1 micron; at least about 0.1 microns and less than about 100, 50, 20, 10, 5, or 1 micron; at least about 0.5 microns and less than about 100, 50, 20, 10, 5, or 1 micron; or at least about 1 micron and less than about 100, 50, 20, 10, or 5 microns. In some cases, the average distance between the outermost surface of electrode 112 (e.g., at interface 122 in FIGS. 1C and 1D) and the innermost surface of electrode 140 and/or electrode 142 (e.g., at interfaces 150A and 150B, respectively, in FIG. 1D) can be less than about 100 microns; less than about 50 microns; less than about 20 microns; less than about 10 microns; less than about 5 microns; less than about 1 micron; at least about 0.1 microns and less than about 100, 50, 20, 10, 5, or 1 micron; at least about 0.5 microns and less than about 100, 50, 20, 10, 5, or 1 micron; or at least about 1 micron and less than about 100, 50, 20, 10, or 5 microns.

In some embodiments, the electrodes and the electrically non-conductive material layer can be constructed and arranged such that, when a voltage is applied to the electrodes and across the dry electrically non-conductive material layer (i.e., prior to the addition of any fluid such as a liquid electrolyte), a relatively high electrical resistance is maintained. In some cases, the electrical resistance between an anode and a cathode within the dry multi-layer structure is at least about 100 Ohms, at least about 1000 Ohms, at least about 10 kiloOhms, at least about 100 kiloOhms, at least about 1 megaOhm, or at least about 10 megaOhms when a voltage of at least about 1 volt is applied across the anode and the cathode. One of ordinary skill in the art would be capable of making such a measurement by applying a voltage drop across the material between the anode and the cathode within the multi-layer structure and measuring the resulting resistance using a multimeter. In some embodiments, the electrical resistances outlined above can be maintained during the application of an anisotropic force (including anisotropic forces defining any of the pressures described herein).

In some cases, the electrical resistance through the thickness of the dry electrically non-conductive material layer (i.e., prior to the addition of any fluid such as a liquid electrolyte) is at least about 100 Ohms, at least about 1000 Ohms, at least about 10 kiloOhms, at least about 100 kiloOhms, at least about 1 megaOhm, or at least about 10 megaOhms when a voltage of at least about 1 volts is applied across the anode and the cathode. One of ordinary skill in the art would be capable of making such a measurement by applying a voltage drop through the thickness of the non-electrically conductive material layer (e.g., by attaching electrodes to surfaces of the non-electrically conductive material layer that are facing away from each other) and measuring the resulting resistance using a multimeter. In some embodiments, the electrical resistances outlined above can be maintained during the application of an anisotropic force (including an anisotropic force defining any of the pressures described herein).

The electrically non-conductive material layer can comprise any material capable of separating or insulating the anode and the cathode from each other to prevent short circuiting (e.g., during use such as during charge and/or discharge of the electrochemical cell), while being constructed and arranged to permit the transport of ions between the anode and the cathode. In some embodiments, all or part of the electrically non-conductive material layer can be formed of a material with a bulk resistivity of at least about 10⁴, at least about 10⁵, at least about 10¹⁰, at least about 10¹⁵, or at least about 10²⁰ Ohm meters.

In some embodiments, the electrically non-conductive material layer can be the electrolyte of the electrochemical cell formed from the multi-layer structure. In other cases, the electrically non-conductive material layer can be a layer separate from the electrolyte of the electrochemical cell formed from the multi-layer structure (i.e., the electrochemical cell can include an electrolyte layer separate from the electrically non-conductive material layer).

All or part of the electrically non-conductive material layer can be formed of a solid electrolyte, in some embodiments. In addition to electrically insulating the anode from the cathode, the solid electrolyte can be ionically conductive, thereby allowing for the transfer of ions between the anode and the cathode. Examples of useful solid polymer electrolytes include, but are not limited to, those comprising one or more polymers selected from the group consisting of polyethers, polyethylene oxides, polypropylene oxides, polyimides, polyphosphazenes, polyacrylonitriles, polysiloxanes, derivatives of the foregoing, copolymers of the foregoing, crosslinked and network structures of the foregoing, and blends of the foregoing.

In some embodiments, all or part of the electrically non-conductive material layer can be formed of a gel. As used herein, the term “gel” refers to a three-dimensional network comprising a liquid and a binder component, in which the liquid is entrained by and not allowed to flow through the binder. Gels can be formed when liquids are entrained within a three-dimensional network of solids upon applying the liquid to the solid network. In some cases, the three-dimensional network within a gel can comprise a liquid entrained within a polymer (e.g., a cross-linked polymer). One of ordinary skill in the art would be capable of determining the difference between a gel and other combinations of a solid and a fluid (e.g., a porous separator and a liquid solvent) by measuring, for example, the absorption stiffness of the gel via a dibutyl phthalate (DBP) uptake test. Generally, upon exposure of the binder component of a gel to a liquid, the weight of the gel will increase, while the weight of a porous separator will not substantially increase. In some embodiments, the binder component of the gel is able to take up liquid in the substantial absence of pores greater than about 10 microns or greater than about 1 micron. The binder component of a gel can be substantially free of pores in some cases. Examples of useful gel polymers for use in electrically non-conductive material layers include, but are not limited to, those comprising one or more polymers selected from the group consisting of polyethylene oxides, polypropylene oxides, polyacrylonitriles, polysiloxanes, polyimides, polyphosphazenes, polyethers, sulfonated polyimides, perfluorinated membranes (NAFION resins), polydivinyl polyethylene glycols, polyethylene glycol diacrylates, polyethylene glycol dimethacrylates, derivatives of the foregoing, copolymers of the foregoing, crosslinked and network structures of the foregoing, and blends of the foregoing, and optionally, one or more plasticizers.

In some embodiments, at least part of the electrically non-conductive material can be formed of a solid, electrically non-conductive material that is partially or substantially filled with a liquid electrolyte. In some such embodiments, the solid material that is partially or substantially filled with a liquid electrolyte can serve as the electrolyte for the electrochemical cell. The solid, electrically non-conductive material can, in some embodiments, be substantially ionically non-conductive. In other cases, the solid, electrically non-conductive might be ionically conductive, and the liquid electrolyte can be used to produce a combined structure with an enhanced ionic conductivity (relative to that of the solid portion of the combination).

A variety of solid, electrically non-conductive separator materials are known in the art. Examples of suitable solid porous separator materials include, but are not limited to, polyolefins, such as, for example, polyethylenes and polypropylenes, glass fiber filter papers, and ceramic materials. Further examples of separators and separator materials suitable for use in this invention are those comprising a microporous xerogel layer, for example, a microporous pseudo-boehmite layer, which may be provided either as a free standing film or by a direct coating application on one of the electrodes, as described in U.S. patent application Ser. Nos. 08/995,089 and 09/215,112 by Carlson et al. of the common assignee. Solid electrolytes and gel electrolytes may also function as a separator in addition to their electrolyte function.

As noted above, a liquid electrolyte can be used to enhance ionic conductivity. In some embodiments, the liquid electrolyte can include one or more ionic electrolyte salts to increase the ionic conductivity. Examples of ionic electrolyte salts for use in the electrolytes described herein include, but are not limited to, LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, and LiN(SO₂CF₃)₂. Other electrolyte salts that may be useful include lithium polysulfides (Li₂Sₓ), and lithium salts of organic ionic polysulfides (LiSₓR)ₙ, where x is an integer from 1 to 20, n is an integer from 1 to 3, and R is an organic group, and those disclosed in U.S. Pat. No. 5,538,812 to Lee et al. A range of concentrations of the ionic lithium salts in the solvent may be used such as from about 0.2 m to about 2.0 m (m is moles/kg of solvent). In some embodiments, a concentration in the range between about 0.5 m to about 1.5 m is used. The addition of ionic lithium salts to the solvent is optional in that upon discharge of Li/S cells the lithium sulfides or polysulfides formed typically provide ionic conductivity to the electrolyte, which may make the addition of ionic lithium salts unnecessary. Furthermore, if an ionic N—O additive such as an inorganic nitrate, organic nitrate, or inorganic nitrite is used, it may provide ionic conductivity to the electrolyte in which case no additional ionic lithium electrolyte salts may be needed.

In one set of embodiments a non-aqueous-based electrolyte is used; in another set of embodiments, an aqueous-based electrolyte is used. Examples of useful non-aqueous liquid electrolyte solvents include, but are not limited to, non-aqueous organic solvents, such as, for example, N-methyl acetamide, acetonitrile, acetals, ketals, esters, carbonates, sulfones, sulfites, sulfolanes, aliphatic ethers, acyclic ethers, cyclic ethers, glymes, polyethers, phosphate esters, siloxanes, dioxolanes, N-alkylpyrrolidones, substituted forms of the foregoing, and blends thereof. Examples of acyclic ethers that may be used include, but are not limited to, diethyl ether, dipropyl ether, dibutyl ether, dimethoxymethane, trimethoxymethane, dimethoxyethane, diethoxyethane, 1,2-dimethoxypropane, and 1,3-dimethoxypropane. Examples of cyclic ethers that may be used include, but are not limited to, tetrahydrofuran, tetrahydropyran, 2-methyltetrahydrofuran, 1,4-dioxane, 1,3-dioxolane, and trioxane. Examples of polyethers that may be used include, but are not limited to, diethylene glycol dimethyl ether (diglyme), triethylene glycol dimethyl ether (triglyme), tetraethylene glycol dimethyl ether (tetraglyme), higher glymes, ethylene glycol divinylether, diethylene glycol divinylether, triethylene glycol divinylether, dipropylene glycol dimethyl ether, and butylene glycol ethers. Examples of sulfones that may be used include, but are not limited to, sulfolane, 3-methyl sulfolane, and 3-sulfolene. Fluorinated derivatives of the foregoing are also useful as liquid electrolyte solvents. Mixtures of the solvents described herein can also be used.

In some embodiments, specific liquid electrolyte solvents that may be favorable towards a lithium anode (e.g., have relatively low reactivity towards lithium, good lithium ion conductivity, and/or relatively low polysulfide solubility) include, but are not limited to 1,1-dimethoxyethane (1,1-DME), 1,1-diethoxyethane, 1,2-diethoxyethane, diethoxymethane, dibutyl ether, anisole or methoxybenzene, veratrole or 1,2-dimethoxybenzene, 1,3-dimethoxybenzene, t-butoxyethoxyethane, 2,5-dimethoxytetrahydrofurane, cyclopentanone ethylene ketal, and combinations thereof. Specific liquid electrolyte solvents that may be favorable towards the cathode (e.g., have relatively high polysulfide solubility, and/or can enable high rate capability and/or high sulfur utilization) include, but are not limited to dimethoxyethane (DME, 1,2-dimethoxyethane) or glyme, diglyme, triglyme, tetraglyme, polyglymes, sulfolane, 1,3-dioxolane (DOL), tetrahydrofurane (THF), acetonirile, and combinations thereof.

Specific mixtures of solvents include, but are not limited to 1,3-dioxolane and dimethoxyethane, 1,3-dioxolane and diethyleneglycol dimethyl ether, 1,3-dioxolane and triethyleneglycol dimethyl ether, and 1,3-dioxolane and sulfolane. The weight ratio of the two solvents in the mixtures may vary from about 5 to 95 to 95 to 5. In some embodiments, a solvent mixture comprises dioxolanes (e.g., greater than 40% by weight of dioxolanes).

In some cases, aqueous solvents can be used as electrolytes for lithium cells. Aqueous solvents can include water, which can contain other components such as ionic salts. In some embodiments, the electrolyte can include species such as lithium hydroxide, or other species rendering the electrolyte basic, so as to reduce the concentration of hydrogen ions in the electrolyte.

In some cases, the electrically non-conductive material layer positioned between an anode and cathode can function to screen the anode (e.g., a base electrode layer of the anode) from any cathode roughness under an applied force or pressure, keeping the anode surface smooth under force or pressure, and stabilizing any multi-layered structures of the anode (e.g., ceramic polymer multi-layer) by keeping the multi-layer pressed between the base electrode layer and the smooth polymer layer. In some such embodiments, the polymer layer may be chosen to be compliant and have a smooth surface.

As noted elsewhere, the multi-layer structures described herein can be part of an electrochemical cell, in some embodiments. The multi-layer structures can be part of a non-rechargeable or rechargeable battery, in some instances. In some cases, the multi-layer structures can be part of a lithium battery, such as a lithium-sulfur battery.

The electrodes described herein can include any suitable electrode active material. As used herein, the term “electrode active material” refers to any electrochemically active species associated with an electrode. For example, a “cathode active material” refers to any electrochemically active species associated with the cathode, while an “anode active material” refers to any electrochemically active species associated with an anode. In addition, the electrodes described herein can include electrode active surfaces. As used herein, the term “active surface” is used to describe a surface of an electrode that is in physical contact with the electrolyte and at which electrochemical reactions may take place. For example, in the set of embodiments illustrated in FIG. 1D, electrode 112 includes an active surface at interface 122, electrode 140 includes an active surface at interface 150A, and electrode 142 includes an active surface at interface 150B.

One or more of the electrodes described herein can be used as the anode of an electrochemical cell. The anode can include any suitable anode active material. In some embodiments, an anode can comprise lithium as the anode active material. For example, the anode can comprise lithium metal as the anode active material. The lithium metal may be in the form of, for example, a lithium metal foil or a thin lithium film that has been deposited on a substrate, as described below. The lithium may also be in the form of a lithium alloy such as, for example, a lithium-tin alloy or a lithium aluminum alloy. The term “alloy” is given its ordinary meaning in the art, and refers to a combination (e.g., solid, solid solution) of two or more elements, wherein at least one element is a metal, and wherein the resulting material has metallic properties.

In many embodiments described herein, lithium rechargeable electrochemical cells (including lithium anodes) are described; however, it is to be understood that any analogous alkali metal battery (alkali metal anode) can be used. Furthermore, in some embodiments, non-lithium based anodes can be used. Additionally, although rechargeable electrochemical cells are primarily disclosed herein, non-rechargeable (primary) electrochemical cells are intended to benefit from the invention as well. Additional arrangements, components, and advantages of alloys are described in more detail in U.S. patent application Ser. No. 11/821,576, filed Jun. 22, 2007, entitled “Lithium Alloy/Sulfur Batteries”, published as U.S. Pub. No. 2008/0318128, which is incorporated herein by reference in its entirety.

In certain embodiments, the thickness of an anode may vary from, e.g., about 2 to 200 microns. For instance, the anode may have a thickness of less than 200 microns, less than 100 microns, less than 50 microns, less than 25 microns, less than 10 microns, or less than 5 microns. The choice of the thickness may depend on multi-layer structure and/or electrochemical cell design parameters such as the excess amount of lithium desired, cycle life, and the thickness of the cathode electrode. In one embodiment, the thickness of the anode active layer is in the range of about 2 to 100 microns (e.g., about 5 to 50 microns, about 5 to 25 microns, or about 10 to 25 microns).

An anode may be deposited by any of a variety of methods generally known in the art, such as physical or chemical vapor deposition methods, extrusion, and electroplating. Examples of suitable physical or chemical vapor deposition methods include, but are not limited to, thermal evaporation (including, but not limited to, resistive, inductive, radiation, and electron beam heating), sputtering (including, but not limited to, diode, DC magnetron, RF, RF magnetron, pulsed, dual magnetron, AC, MF, and reactive), chemical vapor deposition, plasma enhanced chemical vapor deposition, laser enhanced chemical vapor deposition, ion plating, cathodic arc, jet vapor deposition, and laser ablation.

Deposition of the layers may be carried out in a vacuum or inert atmosphere to minimize side reactions in the deposited layers which could introduce impurities into the layers or which may affect the desired morphology of the layers. In some embodiments, anode active layers and the layers of multi-layered structures are deposited in a continuous fashion in a multistage deposition apparatus.

Specifically, methods for depositing an electroactive material such as lithium onto a substrate include methods such as thermal evaporation, sputtering, jet vapor deposition, and laser ablation. Alternatively, where the anode comprises a lithium foil, or a lithium foil and a substrate, these can be laminated together by a lamination process as known in the art, to form an anode layer.

Suitable cathode active materials for use in the cathode of the multi-layer structures (and/or electrochemical cells) described herein include, but are not limited to, electroactive transition metal chalcogenides, electroactive conductive polymers, and electroactive sulfur-containing materials, and combinations thereof. As used herein, the term “chalcogenides” pertains to compounds that contain one or more of the elements of oxygen, sulfur, and selenium. Examples of suitable transition metal chalcogenides include, but are not limited to, the electroactive oxides, sulfides, and selenides of transition metals selected from the group consisting of Mn, V, Cr, Ti, Fe, Co, Ni, Cu, Y, Zr, Nb, Mo, Ru, Rh, Pd, Ag, Hf, Ta, W, Re, Os, and Ir. In one embodiment, the transition metal chalcogenide is selected from the group consisting of the electroactive oxides of nickel, manganese, cobalt, and vanadium, and the electroactive sulfides of iron. In one embodiment, the cathode active layer comprises an electroactive conductive polymer. Examples of suitable electroactive conductive polymers include, but are not limited to, electroactive and electronically conductive polymers selected from the group consisting of polypyrroles, polyanilines, polyphenylenes, polythiophenes, and polyacetylenes.

“Electroactive sulfur-containing materials,” as used herein, relates to cathode active materials which comprise the element sulfur in any form, wherein the electrochemical activity involves the breaking or forming of sulfur-sulfur covalent bonds. Suitable electroactive sulfur-containing materials, include, but are not limited to, elemental sulfur and organic materials comprising sulfur atoms and carbon atoms, which may or may not be polymeric. Suitable organic materials include those further comprising heteroatoms, conductive polymer segments, composites, and conductive polymers.

In some embodiments involving Li/S systems, the sulfur-containing material, in its oxidized form, comprises a polysulfide moiety, Sₘ, selected from the group consisting of covalent —Sₘ-moieties, ionic —Sₘ⁻ moieties, and ionic Sₘ²⁻ moieties, wherein m is an integer equal to or greater than 3. In one embodiment, m of the polysulfide moiety, Sₘ, of the sulfur-containing polymer is an integer equal to or greater than 6. In another embodiment, m of the polysulfide moiety, Sₘ, of the sulfur-containing polymer is an integer equal to or greater than 8. In another embodiment, the sulfur-containing material is a sulfur-containing polymer. In another embodiment, the sulfur-containing polymer has a polymer backbone chain and the polysulfide moiety, Sₘ, is covalently bonded by one or both of its terminal sulfur atoms as a side group to the polymer backbone chain. In yet another embodiment, the sulfur-containing polymer has a polymer backbone chain and the polysulfide moiety, Sₘ, is incorporated into the polymer backbone chain by covalent bonding of the terminal sulfur atoms of the polysulfide moiety.

In one embodiment, the electroactive sulfur-containing material comprises greater than 50% by weight of sulfur. In another embodiment, the electroactive sulfur-containing material comprises greater than 75% by weight of sulfur. In yet another embodiment, the electroactive sulfur-containing material comprises greater than 90% by weight of sulfur.

The nature of the electroactive sulfur-containing materials useful in the practice of this invention may vary widely, as known in the art. In one embodiment, the electroactive sulfur-containing material comprises elemental sulfur. In another embodiment, the electroactive sulfur-containing material comprises a mixture of elemental sulfur and a sulfur-containing polymer.

In other embodiments, a multi-layer structure (and/or electrochemical cell) described herein includes a composite cathode. The composite cathode may include, for example, (a) an electroactive sulfur-containing cathode material, wherein said electroactive sulfur-containing cathode material, in its oxidized state, comprises a polysulfide moiety of the formula —Sₘ—, wherein m is an integer equal to or greater than 3, as described herein; and, (b) an electroactive transition metal chalcogenide composition. In one embodiment, a cathode includes a mixture of an electroactive sulfur-containing cathode material, an electroactive transition metal chalcogenide, and optionally binders, electrolytes, and conductive additives, which is deposited onto a current collector. In another embodiment, a coating of the electroactive sulfur-containing cathode material is encapsulated or impregnated by a thin coherent film coating of the cation transporting, anionic reduction product transport-retarding, transition metal chalcogenide composition. In yet another embodiment, a cathode includes particulate electroactive sulfur-containing cathode materials individually coated with an encapsulating layer of the cation transporting, anionic reduction product transport-retarding, transition metal chalcogenide composition. Other configurations are also possible. Additional arrangements, components, and advantages of composite cathodes are described in more detail in U.S. Pub. No.: 2006/0115579, filed Jan. 13, 2006, entitled “Novel composite cathodes, electrochemical cells comprising novel composite cathodes, and processes for fabricating same”, which is incorporated herein by reference in its entirety.

Cathodes may further comprise one or more conductive fillers to provide enhanced electronic conductivity. Conductive fillers can increase the electrically conductive properties of a material and may include, for example, conductive carbons such as carbon black (e.g., Vulcan XC72R carbon black, Printex XE2, or Akzo Nobel Ketjen EC-600 JD), graphite fibers, graphite fibrils, graphite powder (e.g., Fluka #50870), activated carbon fibers, carbon fabrics, non-activated carbon nanofibers. Other non-limiting examples of conductive fillers include metal coated glass particles, metal particles, metal fibers, nanoparticles, nanotubes, nanowires, metal flakes, metal powders, metal fibers, metal mesh. In some embodiments, a conductive filler may include a conductive polymer. Examples of suitable electroactive conductive polymers include, but are not limited to, electroactive and electronically conductive polymers selected from the group consisting of polypyrroles, polyanilines, polyphenylenes, polythiophenes, and polyacetylenes. Other conductive materials known to those of ordinary skill in the art can also be used as conductive fillers. The amount of conductive filler, if present, may be present in the range of 2 to 30% by weight of the cathode active layer. The cathodes may also further comprise other additives including, but not limited to, metal oxides, aluminas, silicas, and transition metal chalcogenides.

Cathodes may also comprise a binder. The choice of binder material may vary widely so long as it is inert with respect to the other materials in the cathode. In some embodiments, the binder material may be a polymeric material. Examples of polymer binder materials include, but are not limited to, polyvinylidene fluoride (PVDF)-based polymers, such as poly(vinylidene fluoride) (PVDF), PVF₂ and its co- and terpolymers with hexafluoroethylene, tetrafluoroethylene, chlorotrifluoroethylene, poly(vinyl fluoride), polytetrafluoroethylenes (PTFE), ethylene-tetrafluoroethylene copolymers (ETFE), polybutadiene, cyanoethyl cellulose, carboxymethyl cellulose and its blends with styrene-butadiene rubber, polyacrylonitrile, ethylene-propylene-diene (EPDM) rubbers, ethylene propylene diene terpolymers, styrene-butadiene rubbers (SBR), polyimides or ethylene-vinyl acetate copolymers. In some cases, the binder material may be substantially soluble in aqueous fluid carriers and may include, but is not limited to, cellulose derivatives, typically methylcellulose (MC), carboxy methylcellulose (CMC) and hydroxypropyl methylcellulose (HPMC), polyvinyl alcohol (PVA), polyacrylic acid salts, polyacryl amide (PA), polyvinyl pyrrolidone (PVP) and polyethylene oxides (PEO). In one set of embodiments, the binder material is poly(ethylene-co-propylene-co-5-methylene-2-norbornene) (EPMN), which may be chemically neutral (e.g., inert) towards cell components, including polysulfides. UV curable acrylates, UV curable methacrylates, and heat curable divinyl ethers can also be used. The amount of binder, if present, may be present in the range of 2 to 30% by weight of the cathode active layer. In some embodiments, a cathode described herein comprises a conductive porous support structure and a plurality of particles comprising sulfur (e.g., as an active species) substantially contained within the pores of the support structure.

Some embodiments may include multi-layer structures and/or electrochemical devices in which the application of force is used to enhance the performance of the device. Benefits of the application of force in electrochemical cells are described, for example, in U.S. patent application Ser. No. 12/535,328, filed Aug. 4, 2009, published as U.S. Pub. No. 2010/0035128, and entitled “Application of Force In Electrochemical Cells;” U.S. patent application Ser. No. 12/727,862, filed Mar. 19, 2010, entitled “Cathode for Lithium Battery;” U.S. patent application Ser. No. 12/862,581, filed Aug. 24, 2010, entitled “Electrochemical Cells Comprising Porous Structures Comprising Sulfur;” U.S. patent application Ser. No. 12/862,563, filed Aug. 24, 2010, entitled “Electrochemical Cells Comprising Porous Structures Comprising Sulfur;” U.S. patent application Ser. No. 12/862,551, filed Aug. 24, 2010, entitled “Electrochemical Cells Comprising Porous Structures Comprising Sulfur;” and U.S. patent application Ser. No. 12/862,576, filed Aug. 24, 2010, entitled “Electrochemical Cells Comprising Porous Structures Comprising Sulfur.” For example, the application of force to an electrochemical cell (and/or a multi-layer structure) may reduce the amount of roughening of one or more surfaces of one or more electrodes which may improve the cycling lifetime and performance of the cell. In some instances, the force may provide improved electrical conductivity between conductive material in an electrode (e.g., carbon in a cathode). In some embodiments, the multi-layer structures and/or electrochemical cells described herein can include any of the electrically non-conductive material layer thicknesses, electrode spacings, and/or electrically non-conductive material layer resistance properties described herein during the application of a force defining a pressure within any of the ranges described herein and/or using any of the force application methods described herein.

In some embodiments, an anisotropic force can be applied such that a component of the force is normal to an active surface of an electrode (e.g., an anode such as a lithium anode). Referring to FIG. 1D, a force may be applied in the direction of arrow 181. Arrow 182 illustrates the component of the force that is normal to an active surface of electrode 140 at interface 150A and active surface of electrode 142 at interface 150B (as well as the active surfaces of electrode 112 at the top and bottom portions of interface 122). In the case of a curved surface, for example, a concave surface or a convex surface, the force may comprise an anisotropic force with a component normal to a plane that is tangent to the curved surface at the point at which the force is applied.

In some embodiments, an anisotropic force with a component normal to an active surface of the anode is applied during at least one period of time during charge and/or discharge of the electrochemical cell. In some embodiments, the force may be applied continuously, over one period of time, or over multiple periods of time that may vary in duration and/or frequency. The anisotropic force may be applied, in some cases, at one or more pre-determined locations, optionally distributed over an active surface of the anode. In some embodiments, the anisotropic force is applied uniformly over one or more active surfaces of the anode.

An “anisotropic force” is given its ordinary meaning in the art and means a force that is not equal in all directions. A force equal in all directions is, for example, internal pressure of a fluid or material within the fluid or material, such as internal gas pressure of an object. Examples of forces not equal in all directions include forces directed in a particular direction, such as the force on a table applied by an object on the table via gravity. Another example of an anisotropic force includes a force applied by a band arranged around a perimeter of an object. For example, a rubber band or turnbuckle can apply forces around a perimeter of an object around which it is wrapped. However, the band may not apply any direct force on any part of the exterior surface of the object not in contact with the band. In addition, when the band is expanded along a first axis to a greater extent than a second axis, the band can apply a larger force in the direction parallel to the first axis than the force applied parallel to the second axis.

A force with a “component normal” to a surface, for example an active surface of an anode, is given its ordinary meaning as would be understood by those of ordinary skill in the art and includes, for example, a force which at least in part exerts itself in a direction substantially perpendicular to the surface. Those of ordinary skill can understand other examples of these terms, especially as applied within the description of this document.

In some embodiments, the anisotropic force can be applied such that the magnitude of the force is substantially equal in all directions within a plane defining a cross-section of the electrochemical cell (and/or the multi-layer structure), but the magnitude of the forces in out-of-plane directions is substantially unequal to the magnitudes of the in-plane forces.

In one set of embodiments, cells described herein (which can include the multi-layer structures described herein) are constructed and arranged to apply, during at least one period of time during charge and/or discharge of the cell, an anisotropic force with a component normal to the active surface of the anode. Those of ordinary skill in the art will understand the meaning of this. In such an arrangement, the cell (and/or multi-layer structure) may be formed as part of a container which applies such a force by virtue of a “load” applied during or after assembly of the cell, or applied during use of the cell as a result of expansion and/or contraction of one or more portions of the cell itself.

In some embodiments, the electrochemical cells described herein can be configured such that they do not short circuit during application of the anisotropic force (e.g., during use such as during charge and/or discharge of the electrochemical cell and while applying any of the anisotropic forces described herein). In some embodiments, the electrochemical cells described herein do not short circuit during use and during application of the anisotropic force (e.g., any of the forces described herein) over at least 1, at least 2, at least 5, at least 10, at least 50, or at least 100 charge and discharge cycles. As used herein, a “charge and discharge cycle” refers to the process by which a cell is charged from 0% to 100% state of charge (SOC) and discharged from 100% back to 0% SOC. One of ordinary skill in the art would be capable of determining whether an electrochemical cell has short circuited, for example, by measuring the open circuit voltage (OCV) of the electrochemical cell. In some embodiments, the electrochemical cells described herein can be operated such that they do not exhibit a drop in the open circuit voltage of greater than 1 Volt/hour (or such that they do not exhibit a drop in OCV of greater than 100 millivolts/hour, greater than 10 millivolts/hour, greater than 1 millivolts/hour, or greater than 0.1 millivolts/hour) over at least 1, at least 2, at least 5, at least 10, at least 50, or at least 100 charge and discharge cycles (e.g., during application of any of the anisotropic forces described herein).

The magnitude of the applied force is, in some embodiments, large enough to enhance the performance of the electrochemical cell. An anode active surface and the anisotropic force may be, in some instances, together selected such that the anisotropic force affects surface morphology of the anode active surface to inhibit increase in anode active surface area through charge and discharge and wherein, in the absence of the anisotropic force but under otherwise essentially identical conditions, the anode active surface area is increased to a greater extent through charge and discharge cycles. “Essentially identical conditions,” in this context, means conditions that are similar or identical other than the application and/or magnitude of the force. For example, otherwise identical conditions may mean a cell (and/or multi-layer structure) that is identical, but where it is not constructed (e.g., by brackets or other connections) to apply the anisotropic force on the subject cell.

In some embodiments, an anisotropic force with a component normal to an active surface of the anode is applied, during at least one period of time during charge and/or discharge of the cell, to an extent effective to inhibit an increase in surface area of the anode active surface relative to an increase in surface area absent the anisotropic force. The component of the anisotropic force normal to the anode active surface may, for example, define a pressure of at least about 4.9, at least about 9.8, at least about 24.5, at least about 49, at least about 78, at least about 98, at least about 117.6, at least about 147, at least about 175, at least about 200, at least about 225, or at least about 250 Newtons per square centimeter. In some embodiments, the component of the anisotropic force normal to the anode active surface may, for example, define a pressure of less than about 250, less than about 225, less than about 196, less than about 147, less than about 117.6, less than about 98, less than about 49, less than about 24.5, or less than about 9.8 Newtons per square centimeter. In some cases, the component of the anisotropic force normal to the anode active surface is may define a pressure of between about 4.9 and about 147 Newtons per square centimeter, between about 49 and about 117.6 Newtons per square centimeter, between about 68.6 and about 98 Newtons per square centimeter, between about 78 and about 108 Newtons per square centimeter, between about 4.9 and about 250 Newtons per square centimeter, between about 49 and about 250 Newtons per square centimeter, between about 80 and about 250 Newtons per square centimeter, between about 90 and about 250 Newtons per square centimeter, or between about 100 and about 250 Newtons per square centimeter. According to certain embodiments, application of the anisotropic force (defining any of the pressures outlined here) does not cause short circuiting of the electrochemical cell (e.g., during use such as during charge and/or discharge of the electrochemical cell), as described above. In some embodiments, the electrochemical cell can be subjected to at least 1, at least 2, at least 5, at least 10, at least 50, or at least 100 charge and discharge cycles while an anisotropic force is applied (defining any of the pressures described herein) without short circuiting. The force or pressure may, in some embodiments, be externally-applied to the cell, as described herein. While forces and pressures are generally described herein in units of Newtons and Newtons per unit area, respectively, forces and pressures can also be expressed in units of kilograms-force (kg_{f}) and kilograms-force per unit area, respectively. One or ordinary skill in the art will be familiar with kilogram-force-based units, and will understand that 1 kilogram-force is equivalent to about 9.8 Newtons.

In some embodiments, the surface of an electrode layer can be enhanced during cycling (e.g., for lithium, the development of mossy or a rough surface of lithium may be reduced or eliminated) by application of an externally-applied (in some embodiments, uniaxial) pressure. The externally-applied pressure may, in some embodiments, be chosen to be greater than the yield stress of a material forming the electrode material layer. For example, for an electrode material comprising lithium, the cell may be under an externally-applied anisotropic force with a component defining a pressure of at least about 8 kg_{f}/cm², at least about 9 kg_{f}/cm², or at least about 10 kg_{f}/cm². This is because the yield stress of lithium is around 7-8 kg_{f}/cm². Thus, at pressures (e.g., uniaxial pressures) greater than this value, mossy Li, or any surface roughness at all, may be reduced or suppressed. The lithium surface roughness may mimic the surface that is pressing against it. Accordingly, when cycling under at least about 8 kg_{f}/cm², at least about 9 kg_{f}/cm², or at least about 10 kg_{f}/cm² of externally-applied pressure, the lithium surface may become smoother with cycling when the pressing surface is smooth. As described herein, the pressing surface may be modified by choosing the appropriate material(s) positioned between the anode and the cathode. For instance, in some cases the smoothness of the lithium surface (or surface of other active electrode materials) can be increased, during application of pressure, by the use of an electrically non-conductive material layer as described herein.

In some cases, one or more forces applied to the cell have a component that is not normal to an active surface of an anode. For example, in FIG. 1, force 184 is not normal to the active surfaces of electrode 140 at interface 150A and electrode 142 at interface 150B. In one set of embodiments, the sum of the components of all applied anisotropic forces in a direction normal to the anode active surface is larger than any sum of components in a direction that is non-normal to the anode active surface. In some embodiments, the sum of the components of all applied anisotropic forces in a direction normal to the anode active surface is at least about 5%, at least about 10%, at least about 20%, at least about 35%, at least about 50%, at least about 75%, at least about 90%, at least about 95%, at least about 99%, or at least about 99.9% larger than any sum of components in a direction that is parallel to the anode active surface.

In some embodiments, the cathode and anode have yield stresses, wherein the effective yield stress of one of the cathode and anode is greater than the yield stress of the other, such that an anisotropic force applied normal to the surface of one of the active surface of the anode and the active surface of the cathode causes the surface morphology of one of the cathode and the anode to be affected. In some embodiments, the component of the anisotropic force normal to the anode active surface is between about 20% and about 200% of the yield stress of the anode material, between about 50% and about 120% of the yield stress of the anode material, between about 80% and about 120% of the yield stress of the anode material, between about 80% and about 100% of the yield stress of the anode material, between about 100% and about 300% of the yield stress of the anode material, between about 100% and about 200% of the yield stress of the anode material, or between about 100% and about 120% of the yield stress of the anode material.

The anisotropic force described herein may be applied using any method known in the art. In some embodiments, the force may be applied using compression springs. Forces may be applied using other elements (either inside or outside a containment structure) including, but not limited to Belleville washers, machine screws, pneumatic devices, and/or weights, among others. In some cases, cells may be pre-compressed before they are inserted into containment structures, and, upon being inserted to the containment structure, they may expand to produce a net force on the cell. Suitable methods for applying such forces are described in detail, for example, in U.S. Provisional Application No. 61/086,329, filed Aug. 5, 2008, entitled “Application of Force in Electrochemical Cells” to Scordilis-Kelley et al., and U.S. patent application Ser. No. 12/535,328, filed Aug. 4, 2009, entitled “Application of Force in Electrochemical Cells” to Scordilis-Kelley et al. which are incorporated herein by reference in their entirety.

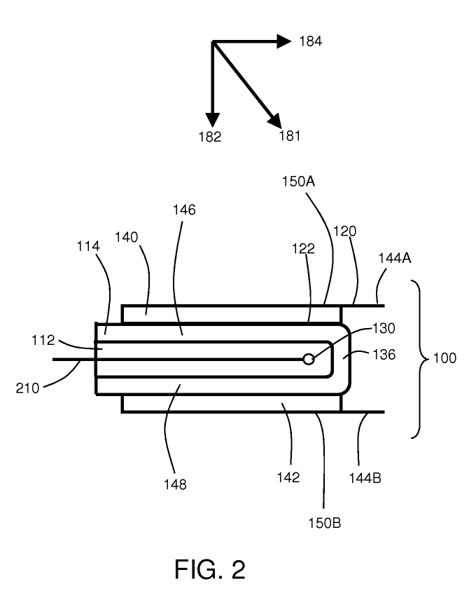

Certain existing methods of fabricating the multi-layer structures and electrochemical cells described herein involve depositing electrode components onto a substrate that is eventually incorporated into an electrochemical cell. The substrate is typically of sufficient thickness and/or formed of a suitable material in order to be compatible with the electrode fabrication process. For example, fabrication of an electrode comprising lithium metal as an electroactive material may involve vacuum deposition of lithium metal at relatively high temperatures and high rates that would cause certain substrates to buckle unless the substrate is made of a certain material or has a sufficient thickness. Some substrates that are suitable for such fabrication steps may, however, end up reducing the performance of the cell if the substrate is incorporated into the cell. For instance, thick substrates may prevent buckling and therefore allow the deposition of a thick layer of an electroactive material, but may reduce the specific energy density of the cell. Furthermore, certain substrates that are incorporated into the electrochemical cell may react adversely with chemical species during cycling. To remedy these issues, certain embodiments described herein may involve methods of fabricating an electrode using a release layer to separate portions of the electrode from a substrate, which can then be removed from the electrode during or after assembly of the electrode into an electrochemical cell. For example, FIG. 2 includes a cross-sectional schematic illustration of an electrochemical cell in which substrate 110 was removed prior to folding the multi-layer structure. In this set of embodiments, electrical contact can be made to electrode 112 via current collector 210. Current collector 210 can be formed, for example, by a release layer or by another layer (e.g., a thin layer of metal) positioned over the release layer. Advantageously, such a method can allow a larger variety of substrates and/or more extreme processing conditions to be used when fabricating electrodes compared to that when the substrate is incorporated into an electrochemical cell. The removal of a substrate from an electrochemical cell can also reduce the number adverse reactions that may occur in the cell during cycling.

In some embodiments described herein, an electrode or an electrochemical cell includes one or more release layers. Release layers described herein are constructed and arranged to have one or more of the following features: relatively good adhesion to a first layer (e.g., a current collector, or in other embodiments, a substrate or other layer) but relatively moderate or poor adhesion to a second layer (e.g., a substrate, or in other embodiments, a current collector or other layer); high mechanical stability to facilitate delamination without mechanical disintegration; high thermal stability; and compatibility with processing conditions (e.g., deposition of layers on top of the release layer, as well as compatibility with techniques used to form the release layer). Release layers may be thin (e.g., less than about 10 microns) to reduce overall battery weight if the release layer is incorporated into the electrochemical cell. A release layer should also be smooth and uniform in thickness so as to facilitate the formation of uniform layers on top of the release layer. Furthermore, release layers should be stable in the electrolyte and should not interfere with the structural integrity of the electrodes in order for the electrochemical cell to have a high electrochemical “capacity” or energy storage capability (i.e., reduced capacity fade). The use of release layers to remove a substrate from one or more components of an electrochemical cell are described in detail in U.S. patent application Ser. No. 12/862,513, filed on Aug. 24, 2010, entitled “Release System for Electrochemimcal Cells.”

The substrate and/or release layer may be formed of, for example, a metal, a ceramic, a polymer, or a combination thereof. As such, the substrate and/or release layer may be conductive, semi-conductive, or insulating. In some embodiments, the substrate and/or release layer comprises a conductive a metal or a conductive polymer. For example, if the release layer also acts as a current collector after being incorporated into the electrochemical cell, the release layer may be formed of a material suitable for use as a current collector, as described in more detail below. In some embodiments, the substrate and/or release layer comprises a polymeric material. In some cases, at least a portion of the polymeric material of the substrate and/or release layer is crosslinked; in other cases, the polymeric material(s) is substantially uncrosslinked. Examples of polymeric materials include, for example, hydroxyl-containing polymers such as poly vinyl alcohol, polyvinyl butyral, polyvinyl formal, vinyl acetate-vinyl alcohol copolymers, ethylene-vinyl alcohol copolymers, and vinyl alcohol-methyl methacrylate copolymers.

The thickness of a release layer may vary over a range from about 0.1 microns to about 50 microns. For instance, the thickness of the release layer may be between 0.1-1 microns thick, between 0.1 and 2 microns thick, between 0.1 and 3 microns thick, between 1-5 microns thick, between 5-10 microns thick, between 5-20 microns thick, or between 10-50 microns thick. In certain embodiments, the thickness of a release layer is, e.g., about 10 microns or less, about 7 microns or less, about 5 microns or less, about 3 microns or less, about 2.5 microns or less, about 2 microns or less, about 1.5 microns or less, about 1 micron or less, or about 0.5 microns or less. A relatively thicker release layer may be suitable for applications where the release layer is not incorporated into an electrochemical cell (e.g., it is released along with a carrier substrate), and a relatively thinner release layer may be desirable where the release layer is incorporated into the electrochemical cell.

Additionally, a substrate may have any suitable thickness. For instance, the thickness of a substrate may about 5 microns or greater, about 15 microns or greater, about 25 microns or greater, about 50 microns or greater, about 75 microns or greater, about 100 microns or greater, about 200 microns or greater, about 500 microns or greater, or about 1 mm or greater. In some cases, the substrate has a thickness that is equal to or greater than the thickness of a release layer formed on the substrate. A relatively thick substrate may be suitable for applications where the substrate is not incorporated into the final assembled electrochemical cell (e.g., it is released through the use of a release layer during fabrication of the cell). In certain embodiments, the substrate is incorporated into the electrochemical cell, and in some such instances it may be desirable to use a relatively thinner substrate.

An electrochemical cell and/or multi-layer structure may include any suitable current collector. In some instances, the current collector is positioned immediately adjacent an electrode within the electrochemical cell and/or multi-layer structure. A current collector is useful in efficiently collecting the electrical current generated throughout an electrode and in providing an efficient surface for attachment of the electrical contacts leading to the external circuit. A wide range of current collectors are known in the art. Suitable current collectors may include, for example, metal foils (e.g., aluminum foil), polymer films, metallized polymer films (e.g., aluminized plastic films, such as aluminized polyester film), electrically conductive polymer films, polymer films having an electrically conductive coating, electrically conductive polymer films having an electrically conductive metal coating, and polymer films having conductive particles dispersed therein.

In some embodiments, the current collector includes one or more conductive metals such as aluminum, copper, chromium, stainless steel and nickel. For example, a current collector may include a copper metal layer. Optionally, another conductive metal layer, such as titanium may be positioned on the copper layer. The titanium may promote adhesion of the copper layer to another material, such as an electroactive material layer. Other current collectors may include, for example, expanded metals, metal mesh, metal grids, expanded metal grids, metal wool, woven carbon fabric, woven carbon mesh, non-woven carbon mesh, and carbon felt. Furthermore, a current collector may be electrochemically inactive. In other embodiments, however, a current collector may comprise an electroactive material. For example, a current collector may include a material which is used as an electroactive material layer (e.g., as an anode or a cathode such as those described herein).

A current collector may be positioned on a surface (e.g., a surface of a release layer) by any suitable method such as lamination, sputtering, and vapor deposition. In some cases, a current collector is provided as a commercially available sheet that is laminated with an electrochemical cell and/or multi-layer structure component. In other cases, a current collector is formed during fabrication of the electrode by depositing a conductive material on a suitable surface.

A current collector may have any suitable thickness. For instance, the thickness of a current collector may be, for example, between 0.1 and 0.5 microns thick, between 0.1 and 0.3 microns thick, between 0.1 and 2 microns thick, between 1-5 microns thick, between 5-10 microns thick, between 5-20 microns thick, or between 10-50 microns thick. In certain embodiments, the thickness of a current collector is, e.g., about 20 microns or less, about 12 microns or less, about 10 microns or less, about 7 microns or less, about 5 microns or less, about 3 microns or less, about 1 micron or less, about 0.5 micron or less, or about 0.3 micron or less. In some embodiments, the use of a release layer during fabrication of an electrode can allow the formation or use of a very thin current collector, which can reduce the overall weight of the cell (and/or multi-layer structure), thereby increasing the cell's energy density.

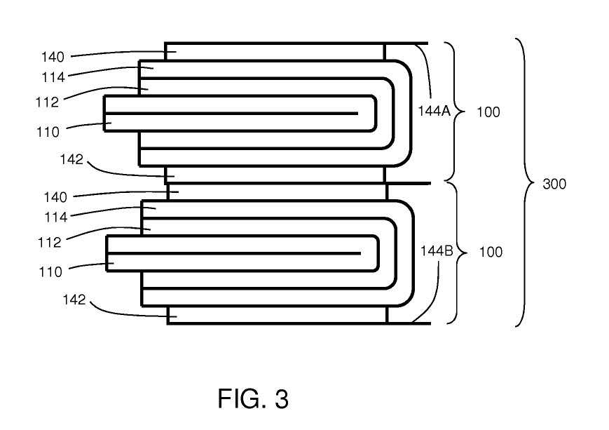

In some embodiments, multiple multi-layer structures can be stacked on top of each other to form electrochemical batteries with higher voltages (e.g., in the case of a series electrical connection) or with higher capacity and current handling (e.g., in the case of a parallel electrical connection), relative to a single multi-layer structure. For example, in the set of embodiments illustrated in FIG. 3, two multi-layer structures have been stacked on top of each other to form stack 300. In some embodiments, a stack of multi-layer structures can include at least 2, at least 3, at least 4, at least 5, at least 10, at least 50, at least 100, or more multi-layer structures.

U.S. Provisional Patent Application Ser. No. 61/376,554, filed Aug. 24, 2010, and entitled “Electrically Non-Conductive Materials for Electrochemical Cells” is incorporated herein by reference in its entirety for all purposes. In addition, the following documents are incorporated herein by reference in their entireties for all purposes: U.S. Pat. No. 7,247,408, filed May 23, 2001, entitled “Lithium Anodes for Electrochemical Cells”; U.S. Pat. No. 5,648,187, filed Mar. 19, 1996, entitled “Stabilized Anode for Lithium-Polymer Batteries”; U.S. Pat. No. 5,961,672, filed Jul. 7, 1997, entitled “Stabilized Anode for Lithium-Polymer Batteries”; U.S. Pat. No. 5,919,587, filed May 21, 1997, entitled “Novel Composite Cathodes, Electrochemical Cells Comprising Novel Composite Cathodes, and Processes for Fabricating Same”; U.S. patent application Ser. No. 11/400,781, filed Apr. 6, 2006, published as U.S. Pub. No. 2007-0221265, and entitled “Rechargeable Lithium/Water, Lithium/Air Batteries”; International Patent Apl. Serial No.: PCT/US2008/009158, filed Jul. 29, 2008, published as International Pub. No. WO/2009017726, and entitled “Swelling Inhibition in Lithium Batteries”; U.S. patent application Ser. No. 12/312,764, filed May 26, 2009, published as U.S. Pub. No. 2010-0129699, and entitled “Separation of Electrolytes”; International Patent Apl. Serial No.: PCT/US2008/012042, filed Oct. 23, 2008, published as International Pub. No. WO/2009054987, and entitled “Primer for Battery Electrode”; U.S. patent application Ser. No. 12/069,335, filed Feb. 8, 2008, published as U.S. Pub. No. 2009-0200986, and entitled “Protective Circuit for Energy-Storage Device”; U.S. patent application Ser. No. 11/400,025, filed Apr. 6, 2006, published as U.S. Pub. No. 2007-0224502, and entitled “Electrode Protection in both Aqueous and Non-Aqueous Electrochemical Cells, including Rechargeable Lithium Batteries”; U.S. patent application Ser. No. 11/821,576, filed Jun. 22, 2007, published as U.S. Pub. No. 2008/0318128, and entitled “Lithium Alloy/Sulfur Batteries”; patent application Ser. No. 11/111,262, filed Apr. 20, 2005, published as U.S. Pub. No. 2006-0238203, and entitled “Lithium Sulfur Rechargeable Battery Fuel Gauge Systems and Methods”; U.S. patent application Ser. No. 11/728,197, filed Mar. 23, 2007, published as U.S. Pub. No. 2008-0187663, and entitled “Co-Flash Evaporation of Polymerizable Monomers and Non-Polymerizable Carrier Solvent/Salt Mixtures/Solutions”; International Patent Apl. Serial No.: PCT/US2008/010894, filed Sep. 19, 2008, published as International Pub. No. WO/2009042071, and entitled “Electrolyte Additives for Lithium Batteries and Related Methods”; International Patent Apl. Serial No.: PCT/US2009/000090, filed Jan. 8, 2009, published as International Pub. No. WO/2009/089018, and entitled “Porous Electrodes and Associated Methods”; U.S. patent application Ser. No. 12/535,328, filed Aug. 4, 2009, published as U.S. Pub. No. 2010/0035128, and entitled “Application of Force In Electrochemical Cells”; U.S. patent application Ser. No. 12/727,862, filed Mar. 19, 2010, entitled “Cathode for Lithium Battery”; U.S. patent application Ser. No. 12/471,095, filed May 22, 2009, entitled “Hermetic Sample Holder and Method for Performing Microanalysis Under Controlled Atmosphere Environment”; U.S. patent application Ser. No. 12/862,513, filed on Aug. 24, 2010, entitled “Release System for Electrochemimcal Cells;” (which claims priority to Provisional Patent Apl. Ser. No. 61/236,322, filed Aug. 24, 2009, entitled “Release System for Electrochemical Cells”); U.S. patent application Ser. No. 12/862,581, filed Aug. 24, 2010, entitled “Electrochemical Cells Comprising Porous Structures Comprising Sulfur” [Attorney Docket No.: S1583.7002411501]; U.S. patent application Ser. No. 12/862,563, filed Aug. 24, 2010, entitled “Electrochemical Cells Comprising Porous Structures Comprising Sulfur” Attorney Docket No.: [S1583.70029US00]; U.S. patent application Ser. No. 12/862,551, filed Aug. 24, 2010, entitled “Electrochemical Cells Comprising Porous Structures Comprising Sulfur” [Attorney Docket No.: S1583.70030US00]; U.S. patent application Ser. No. 12/862,576, filed Aug. 24, 2010, entitled “Electrochemical Cells Comprising Porous Structures Comprising Sulfur” [Attorney Docket No.: S1583.70031US00]; U.S. Patent Application Ser. No. 61/385,343, filed on Sep. 22, 2010, entitled “Low Electrolyte Electrochemical Cells;” U.S. patent application Ser. No. 13/033,419, filed Feb. 23, 2011, entitled “Porous Structures for Energy Storage Devices;” U.S. patent application Ser. No. 12/862,528, filed on Aug. 24, 2010, entitled “Electrochemimcal Cell;” and U.S. Provisional Patent Application Ser. No. 61/498,339, filed on Jun. 17, 2011, and entitled “Plating Technique for Electrode.” All other patents and patent applications disclosed herein are also incorporated by reference in their entirety for all purposes.

The following examples are intended to illustrate certain embodiments of the present invention, but do not exemplify the full scope of the invention.

### Example 1

This example describes the fabrication and use of an electrochemical cell comprising an electrode coated with an electrically non-conductive material layer and folded to form the cell. In this example, a lithium anode and sulfur cathode were employed.

To produce the electrically non-conductive material-coated anode, a conductive 0.1-micron thick Cu layer was deposited on a 50-micron thick polyethylene terephthalate (PET) substrate. In addition, a 25-micron thick lithium layer was vacuum deposited on the structure. Next, the stack of materials was coated with a 9-micron thick polymer/SiO₂ composite electrically non-conductive material. The composite electrically non-conductive material was created through coating and UV curing a mixture with the following composition: glycydil butyl ether (83.5 wt %), Bis-phenol-F (10 wt %), photoinitiator PC-2506 (2 wt %), and TS-720 silica (4.5 wt %). After coating a layer of a mixture with the above composition, the sample was passed under UV light with web speed 3 ft/min. The coated and cured layer, once dried, was subjected to electrical resistance measurements. A copper block with a polished surface with area of 47 cm² was placed on the coated surface. A multimeter connected to the copper block and the lithium anode showed an open circuit or resistance (i.e., a resistance higher than 10⁸ Ohms. For the 9 micron thick layer, this translated to an electrical resistance of greater than 5.22*10¹⁰ Ohm meters, as calculated using the following formula:

$$Specific Resistance = \frac{Resistance \cdot Area}{Thickness}$$

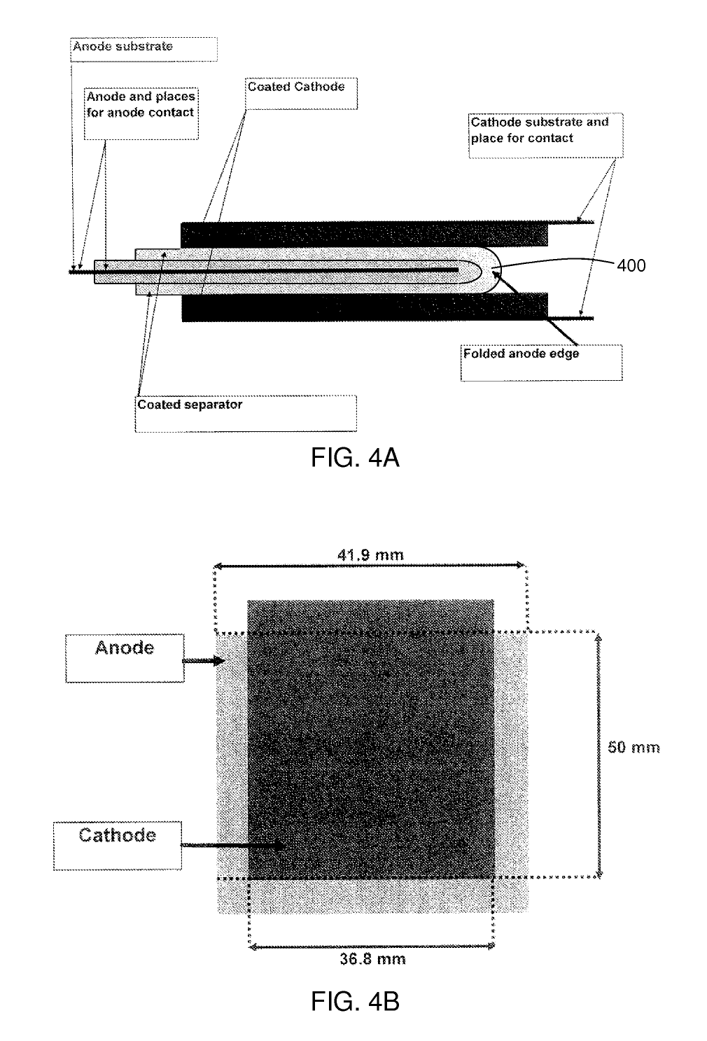

The electrically non-conductive material-coated anode was folded to form the anode structure shown in FIG. 4A. The uncoated surface of the lithium was laminated to produce an anode coated with electrically non-conductive material on two sides, and a protected edge along the folded edge (400 in FIG. 4A). Cathodes were placed on either side of the folded and laminated anode to produce the sandwich structure shown in FIG. 4A. The cathodes were coated on 7 micron thick primed Al foil, and had the following composition: 55 wt % sulfur, 20 wt % XE-2 carbon, 20 wt % Vulcan carbon, and 5 wt % PVOH binder. The sulfur loading per cathode unit area was of 1.85 mg/cm². The active area of the electrodes, as illustrated in the top down view shown in FIG. 4B, were 36.8 cm² (2×36.8 mm×50 mm). The ohm-meter indicated an open circuit or a resistance higher than 100 megaohms (>10⁸ ohms) during the operation of the dry cell. The large measured resistance indicated that the electrode assembly exhibited no short circuiting, which would lead to capacity loss due to self-discharge.

The dry Li—S cells were activated with liquid electrolyte (a solution of 4% lithium nitrate, 8% lithium bis-(trifluoromethylsulfon)imide, 1% guanidinium nitrate, and 0.4% pyridinium nitrate in 43.8% 1,2-dimethoxy ethane and 43.8% 1,3-dioxolane). After activation with electrolyte the cell soaked over 24 hours. During this time coated polymer layer on the anode surface absorbed electrolyte and became ionically conductive. After soaking, the cells were cycled under 10 kg/cm² pressure and with a discharge current 13.7 mA and a charge current 7.8 mA. Cells delivered a discharge specific capacity of 850-950 mAh/g of sulfur.

### Comparative Example 1

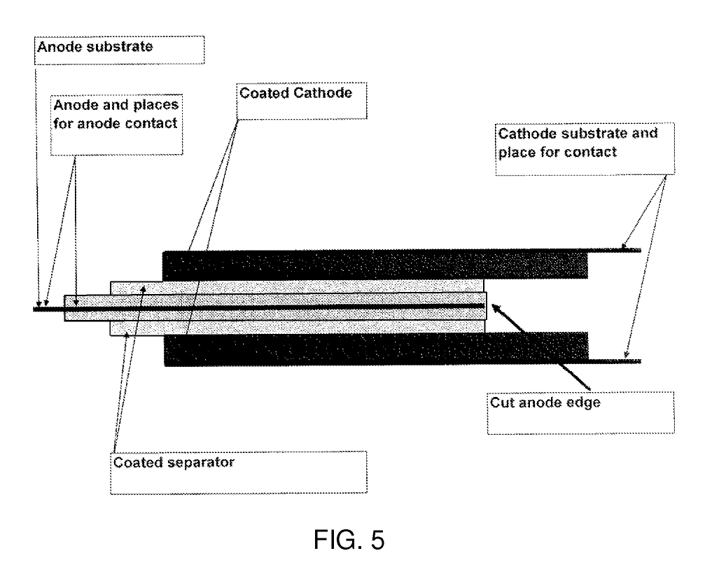

In this comparative example, electrochemical cells comprising anodes with unprotected edges were fabricated and tested. The coated anodes included similar materials and thicknesses as those outlined in Example 1. However, in this set of tests, the anodes were fabricated by coating two anodes on a single side and laminating them together, rather than folding. The resulting anodes did not include any folded edges, and thus, anode material was exposed around the perimeter of the anode/non-electrically conductive material composite, as shown in FIG. 5. Sulfur cathodes were prepared using similar materials and methods as those described in Example 1. A laminated anode and two cathodes were assembled into a sandwich structure, as shown in the schematic cross-section in FIG. 5.

Electrochemical cells assembled as shown in FIG. 5 were subjected to compression and tested. Upon placing a mass of 0.1 kg on the cells, a resistance of 66 ohms was observed. Application of a 1.6 kg mass resulted in a resistance of just 5.5 ohms. These levels of resistance indicated that a short circuit was present in the cells during operation. Such resistance levels indicate that the electrochemical cell would lose all of its capacity over just a few minutes when activated with an electrolyte.

### Example 2

This example describes the fabrication and use of an electrochemical cell comprising an electrode coated with an electrically non-conductive material layer and folded to form the cell. In this example, a lithium anode and sulfur cathode were employed.

To produce the electrically non-conductive material-coated anode, a conductive 0.2-micron thick Cu layer was deposited on a 50-micron thick polyethylene terephthalate (PET) substrate. In addition, a 25-micron thick lithium layer was vacuum deposited on the structure. Next, a composite of polyvinyl alcohol (Celvol 425) (55 wt %) and lithium bis-(trifluoromethylsulfon)imide (45 wt %) in dimethyl sulfoxide (DMSO) was coated on the top of the lithium. The thickness of dry electrically non-conductive material was 25 microns.

Batteries containing the above-described electrically non-conductive material-coated anode, cathode and separator were assembled in a similar fashion as described in Example 1. The cathodes were coated on 7-micron thick primed aluminum foil, and had the following composition: 55 wt % sulfur, 20 wt % XE-2 carbon, 20 wt % Vulcan carbon, and 5 wt % PVOH binder. The sulfur loading per cathode unit area was of 1.85 mg/cm². The active areas of the electrodes were 36.8 cm² (2×36.8 mm×50 mm). The dry Li—S cells were activated with liquid electrolyte (a solution of 4% lithium nitrate, 8% lithium bis-(trifluoromethylsulfon)imide, 1% guanidinium nitrate, and 0.4% pyridinium nitrate in 43.8% 1,2-dimethoxy ethane and 43.8% 1,3-dioxolane). After activation with electrolyte the cell soaked over 24 hours. During this time, the coated polymer layer on the anode surface absorbed electrolyte and became ionically conductive. After soaking, the cells were cycled under an anisotropic force defining a pressure of 10 kg/cm² and with a discharge current 13.7 mA and a charge current 2 mA. Cells delivered a discharge specific capacity of 1040-1060 mAh/g of sulfur.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method, comprising:
providing a multi-layer structure comprising:
an electrically non-conductive material layer,
a substantially continuous electrode including an electrode surface oriented away from the electrically non-conductive material layer, and defining a first electrode surface portion and a second electrode surface portion; and
folding the multi-layer structure along an axis such that the first electrode surface portion faces the second electrode surface portion.

2. The method of claim 1, wherein the electrically non-conductive material layer and the electrode are in contact.

3. The method of claim 1, wherein the electrically non-conductive material layer and the electrode include at least one intermediate material between them.

4. The method of claim 1, wherein providing the multi-layer structure comprises positioning the electrically non-conductive material layer and the electrode adjacent each other to form the multi-layer structure.

5. The method of claim 1, wherein the electrode is an anode.

6. The method of claim 1, wherein the electrode is a cathode.

7. The method of claim 4, wherein positioning the electrically non-conductive material layer and the electrode adjacent each other comprises forming the electrically non-conductive material layer on the electrode.

8. The method of claim 1, wherein the first portion of the exposed electrode surface is in contact with the second portion of the exposed electrode surface.

9. The method of claim 1, wherein the first portion of the exposed electrode surface is spaced apart from the second portion of the exposed electrode surface.

10. The method of claim 1, further comprising positioning a second electrode adjacent at least a portion of the exposed coating surface, wherein
the first electrode has a first polarity, and
the second electrode has a second polarity that is opposite the first polarity.

11. The method of claim 1, wherein the electrode is formed on a substrate.

12. The method of claim 11, wherein the substrate is electrically conductive.

13. The method of claim 10, further comprising applying an anisotropic force with a component normal to an active surface of the first and/or second electrode.

14. The method of claim 13, wherein the electrical resistance between the first and second electrode is at least about 100 Ohms when a voltage of at least about 1 volt is applied across the first and second electrode.

15. The method of claim 13, wherein the anisotropic force defines a pressure of at least about 4.9 Newtons per square centimeter.

16. A multi-layer structure, wherein a cross-section taken through the bulk of the structure comprises:
a first electrode layer portion having a first polarity;
a second electrode layer portion having a second polarity that is opposite the first polarity;
a third electrode layer portion having the first polarity;
a first electrically non-conductive material layer portion between the first and second electrode layer portions; and
a second electrically non-conductive material layer portion between the second and third electrode portions, wherein:
the first and second electrically non-conductive material layer portions are directly connected by a third portion of an electrically non-conductive material; and
the average distance between the first and second electrode layer portion and/or the average distance between the second and third electrode layer portion is less than about 100 microns.

17. The multi-layer structure of claim 16, wherein the first, second, and third electrically non-conductive material layer portions are each part of a substantially continuous electrically non-conductive material layer.

18. The multi-layer structure of claim 16, wherein at least one of the electrode layer portions is part of an anode.

19. The multi-layer structure of claim 18, wherein the anode comprises lithium.

20. The multi-layer structure of claim 16, wherein the first and third electrode layer portions are part of an anode, and the second electrode layer portion is part of a cathode.

21. The multi-layer structure of claim 16, wherein at least one of the electrode layer portions is part of a cathode.

22. The multi-layer structure of claim 21, wherein the cathode comprises sulfur.

23. The multi-layer structure of claim 16, wherein the first and third electrode layer portions are part of a cathode, and the second electrode layer portion is part of an anode.

24. The multi-layer structure of claim 16, wherein the average distance between the first and second electrode layer portions is less than about 100 microns.

25. The multi-layer structure of claim 16, wherein the average distance between the first and second electrode layer portions is less than about 50 microns.

26. The multi-layer structure of claim 16, wherein the average distance between the first and second electrode layer portions is less than about 20 microns.

27. The multi-layer structure of claim 16, wherein the average distance between the first and second electrode layer portions is less than about 10 microns.

28. The multi-layer structure of claim 16, wherein the average distance between the first and second electrode layer portions is less than about 5 microns.

29. The multi-layer structure of claim 16, wherein the average distance between the first and second electrode layer portions is less than about 1 micron.

30. The multi-layer structure of claim 16, wherein the average distance between the second and third electrode layer portions is less than about 100 microns.

31. The multi-layer structure of claim 16, wherein the average distance between the second and third electrode layer portions is less than about 50 microns.

32. The multi-layer structure of claim 16, wherein the average distance between the second and third electrode layer portions is less than about 20 microns.

33. The multi-layer structure of claim 16, wherein the average distance between the second and third electrode layer portions is less than about 10 microns.

34. The multi-layer structure of claim 16, wherein the average distance between the second and third electrode layer portions is less than about 5 microns.

35. The multi-layer structure of claim 16, wherein the average distance between the second and third electrode layer portions is less than about 1 micron.

36. The multi-layer structure of claim 16, wherein at least one of the first and/or second electrically non-conductive material layer portions is covalently bonded to at least one of the first, second, and/or third electrode layer portions.

37. The multi-layer structure of claim 36, wherein at least one of the first and/or second electrically non-conductive material layer portions is covalently bonded to the second electrode layer portion.

38. The multi-layer structure of claim 16, wherein at least one of the first and/or second electrically non-conductive material layer portions comprises a coating formed on the second electrode layer portion.

39. The multi-layer structure of claim 16, wherein at least one of the first and/or second electrically non-conductive material layer portions comprises a polymer.

40. The multi-layer structure of claim 16, further comprising a current collector between two portions of the second electrode layer portion.

41. The multi-layer structure of claim 40, wherein the current collector comprises a substrate on which the second electrode layer is formed.

42. The multi-layer structure of claim 16, wherein at least one of the first electrode layer portion and the second electrode layer portion is in contact with the electrically non-conductive material layer.

43. The multi-layer structure of claim 16, wherein at least one of the first electrode layer portion and the second electrode layer portion is spaced apart from the electrically non-conductive material layer.

44. The multi-layer structure of claim 16, wherein the multi-layer structure is part of an electrochemical cell.

45. The multi-layer structure of claim 16, wherein the multi-layer structure is part of a rechargeable battery.

46. The multi-layer structure of claim 16, wherein the multi-layer structure is configured such that an anisotropic force with a component normal to an active surface of the first, second, and/or third electrode layer is applied to the multi-layer structure.

47. The multi-layer structure of claim 46, wherein the electrical resistance between the first and second electrode layers is at least about 100 Ohms when a voltage of at least about 1 volt is applied across the first and second electrode layers.

48. The multi-layer structure of claim 46, wherein the anisotropic force defines a pressure of at least about 4.9 Newtons per square centimeter.

49. An electrochemical cell, comprising:
a first electrode portion with a first polarity;
a second electrode portion with a second polarity that is opposite the first polarity;
a third electrode portion with the first polarity; and
a substantially continuous, electrically non-conductive material layer having a first portion between the first electrode portion and the second electrode portion, a second portion between the second electrode portion and the third electrode portion, and a third portion in direct contact with the first and second portions, wherein
the average distance between the first and second electrode layer portions and/or the average distance between the second and third electrode layer portion is less than about 100 microns.

50. The electrochemical cell of claim 49, wherein the electrically non-conductive material layer exhibits an electrical resistance, when dry, of at least about 10⁵ Ohm meters.

51. The electrochemical cell of claim 49, wherein the first and third electrode portions are part of anodes, and the second electrode portion is part of a cathode.

52. The electrochemical cell of claim 49, wherein the first and third electrode portions are part of cathodes, and the second electrode portion is part of an anode.

53. The electrochemical cell of claim 49, wherein the average distance between the first electrode portion and the second electrode portion is less than about 100 microns.

54. The electrochemical cell of claim 49, wherein the average distance between the second electrode portion and the third electrode portion is less than about 100 microns.

55. The electrochemical cell of claim 49, wherein the electrically non-conductive material layer is covalently bonded to the second electrode portion.

56. The electrochemical cell of claim 49, wherein the electrically non-conductive material layer comprises a coating formed on the second electrode portion.

57. The electrochemical cell of claim 49, wherein at least one of the first electrode portion, the second electrode portion, and the third electrode portion is in contact with the electrically non-conductive material layer.

58. The electrochemical cell of claim 49, wherein at least one of the first and third electrode portions is substantially planar.

59. The electrochemical cell of claim 49, wherein the electrochemical cell is configured such that an anisotropic force with a component normal to an active surface of the first, second, and/or third electrode is applied to the electrochemical cell.

60. The electrochemical cell of claim 59, wherein, during use, the electrochemical cell does not short circuit during application of the anisotropic force.

61. The electrochemical cell of claim 59, wherein the anisotropic force defines a pressure of at least about 4.9 Newtons per square centimeter.

62. An electrochemical cell, comprising:
A substrate with a first substrate surface portion, and a second substrate surface portion facing away from the first substrate surface portion;
a first electrode with a first portion adjacent the first substrate surface portion and a second portion adjacent the second substrate surface portion;
a second electrode with a first surface portion facing the first portion of the first electrode and a second surface portion facing away from the first surface portion of the second electrode; and
a substantially continuous, electrically non-conductive material layer having a first portion between the first portion of the first electrode and the first surface portion of the second electrode, a second portion adjacent the second surface portion of the first electrode, and a third portion in direct contact with the first and second portions.

63. The electrochemical cell of claim 62, wherein the electrochemical cell exhibits an electrical resistance of at least about 100 Ohms when a voltage of at least about 1 Volt is applied across the first and second electrodes.

64. The electrochemical cell of claim 62, wherein the substrate is electrically conductive.

65. The electrochemical cell of claim 62, wherein the first electrode is in contact with the substrate.

66. The electrochemical cell of claim 62, wherein at least one intermediate material is positioned between the first electrode and the substrate.

67. The electrochemical cell of claim 62, wherein the electrically non-conductive material layer is in contact with the first electrode.

68. The electrochemical cell of claim 62, wherein the electrically non-conductive material layer comprises a substantially continuous layer positioned on the first electrode.

69. The electrochemical cell of claim 62, wherein the electrochemical cell is configured such that an anisotropic force with a component normal to an active surface of the first and/or second electrode is applied to the electrochemical cell.

70. The electrochemical cell of claim 69, wherein, during use, the electrochemical cell does not short circuit during application of the anisotropic force.

71. The electrochemical cell of claim 69, wherein the anisotropic force defines a pressure of at least about 4.9 Newtons per square centimeter.

72. An electrochemical cell, comprising a multi-layer structure including the following layer portions positioned in the order described, optionally with any number of other layers of the same or different material intervening the described layers:
a first electrode layer portion having a first polarity;
a second electrode layer portion having a second polarity;
a third electrode layer portion having the second polarity; and
a fourth electrode layer portion having the first polarity,
wherein the second electrode layer portion and the third electrode layer portion are portions of a single, substantially continuous electrode, and
wherein no electrode portion having the first polarity is positioned intervening the second and third electrode layer portions.

73. The electrochemical cell of claim 72, further comprising an electrically non-conductive material layer portion between the first electrode layer portion and the second electrode layer portion.

74. The electrochemical cell of claim 72, further comprising an electrically non-conductive material layer portion between the third electrode layer portion and the fourth electrode layer portion.

75. The electrochemical cell of claim 72, further comprising a first electrically non-conductive material layer portion between the first electrode layer portion and the second electrode layer portion and a second electrically non-conductive material layer portion between the third electrode layer portion and the fourth electrode layer portion.

76. The electrochemical cell of claim 75, wherein the first and second electrically non-conductive material layer portions are directly connected.

77. The electrochemical cell of claim 75, wherein the first and second electrically non-conductive material layer portions are each part of a substantially continuous layer.

78. The electrochemical cell of claim 72, further comprising a first substrate portion between the second electrode layer portion and the third electrode layer portion.

79. The electrochemical cell of claim 78, further comprising a second substrate portion between the first substrate portion and the second electrode layer portion.

80. The electrochemical cell of claim 79, wherein the first and second substrate portions are each part of a substantially continuous substrate.

81. The electrochemical cell of claim 72, wherein the electrochemical cell is configured such that an anisotropic force with a component normal to an active surface of the first electrode layer portion, the second electrode layer portion, the third electrode layer portion, and/or the fourth electrode layer portion is applied to the electrochemical cell.

82. The electrochemical cell of claim 81, wherein, during use, the electrochemical cell does not short circuit during application of the anisotropic force.

83. The electrochemical cell of claim 81, wherein the anisotropic force defines a pressure of at least about 4.9 Newtons per square centimeter.
